(19) United States
(12) Patent Application Publication
(10) Pub. No.: US 2011/0264997 A1
(43) Pub. Date: Oct. 27, 2011

(54) Scalable Incremental Semantic Entity and Relatedness Extraction from Unstructured Text

(75) Inventors: Kunal Mukerjee, Redmond, WA (US); Sorin Gherman, Kirkland, WA (US)

(73) Assignee: MICROSOFT CORPORATION, Redmond, WA (US)

(21) Appl. No.: 12/764,107

(22) Filed: Apr. 21, 2010

(51) Int. Cl. G06F 17/30; G06F 17/21

(52) U.S. Cl. 715/256; 707/769; 707/E17.014

(57) ABSTRACT

A search engine for documents containing text may process text using a statistical language model, classify the text based on entropy, and create suffix trees or other mappings of the text for each classification. From the suffix trees or mappings, a graph may be constructed with relationship strengths between different words or text strings. The graph may be used to determine search results, and may be browsed or navigated before viewing search results. As new documents are added, they may be processed and added to the suffix trees, then the graph may be created on demand in response to a search request. The graph may be represented as a adjacency matrix, and a transitive closure algorithm may process the adjacency matrix as a background process.

### BACKGROUND

Searching text is a task often performed by web search engines, as well as search engines for desktop and local area network environments. Much of the data stored in a file system, website, or other database may be in textual form.

Keyword searches may return results from documents that have an exact match. When a keyword search also searches for a synonym, the search may return additional results. However, keyword searches may not uncover relationships between different concepts or terms in the documents.

### SUMMARY

A search engine for documents containing text may process text using a statistical language model, classify the text based on entropy, and create suffix trees or other mappings of the text for each classification. From the suffix trees or mappings, a graph may be constructed with relationship strengths between different words or text strings. The graph may be used to determine search results, and may be browsed or navigated before viewing search results. As new documents are added, they may be processed and added to the suffix trees, then the graph may be created on demand in response to a search request. The graph may be represented as an adjacency matrix, and a transitive closure algorithm may process the adjacency matrix as a background process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a search engine and an environment in which search engine may operate.

FIG. 2 is a flowchart illustration of an embodiment showing a general method for indexing text items and processing queries.

FIG. 3 is a diagram illustration of an example embodiment showing an entropy sorted pyramid.

FIG. 4 is a flowchart illustration of an embodiment showing a method for performing transitive closure, which may be performed as a background process.

FIG. 5 is a flowchart illustration of an embodiment showing a method for responding to a search query and presenting results.

### DETAILED DESCRIPTION

A search engine may receive items to index, and may use a statistical language model to classify and group elements from the items. The grouping may be based on the ‘entropy’ or rareness of the items, and may form an entropy sorted pyramid. Each grouping may be added to a data structure for that group, where the data structure may be a suffix tree or other structure. The various data structures may be consolidated into a graph that represents each element and relationships to other elements. Each relationship may have an associated relationship strength.

The search engine may process any type of items using any type of elements within those items. In an example embodiment, text strings within items are used to highlight how the search engine may operate, although any type of elements may be searched using different embodiments.

The mechanism for indexing new items when those items are added to the searchable database is scalable. Regardless of the size of the database, a new item may be added to the searchable database with approximately the same processing time. A transitive closure algorithm may operate on the database to identify implied relationships between items.

When the database is small, the transitive closure algorithm may fill in relationships within the database that are implied by not expressly shown between the elements in the database. Because the corpus of documents may be small, the transitive closure algorithm may be performed quickly. When the database is extremely large, the transitive closure algorithm may still process, but the large number of items in the database may already possess many of the relationships. Because of this property, the transitive closure algorithm may operate as a background process and may be omitted in very large corpuses.

Throughout this specification and claims the terms ‘item’ and ‘element’ are used to denote specific things. An ‘item’ is used to denote a unit that is indexed and searchable using a search engine. An ‘item’ may be a document, website, web page, email, or other unit that is searched an indexed.

An ‘element’ is the indexed unit that makes up an ‘item’. In a text based search system, an ‘element’ may be a word or phrase, for example. An ‘element’ is a unit defined in the search index as having relationships to other elements.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

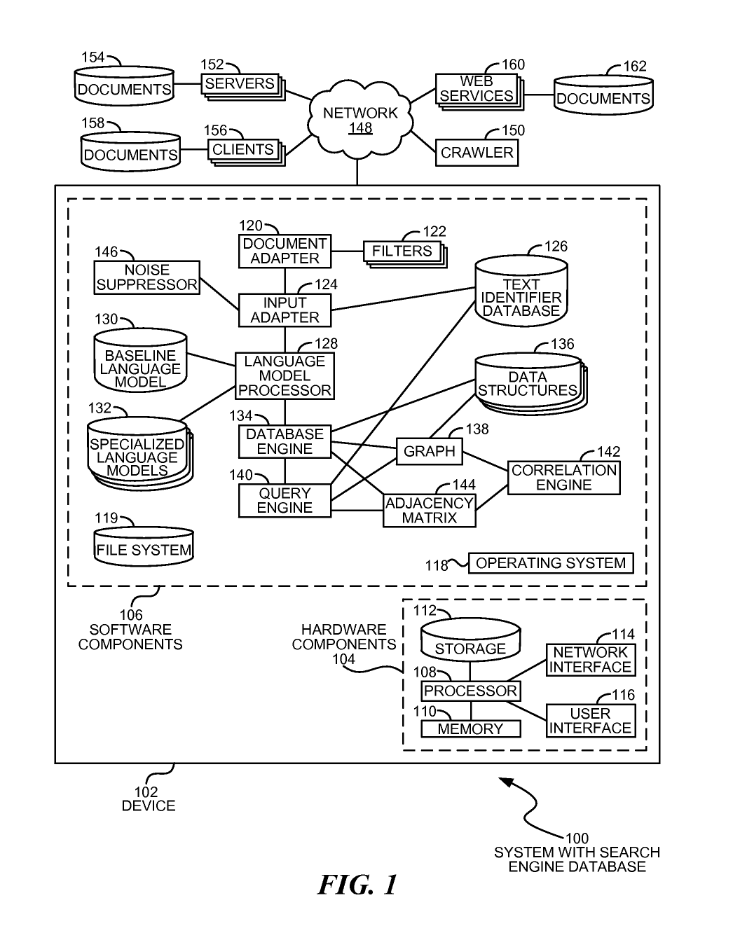

FIG. 1 is a diagram of an embodiment 100, showing a system with a search engine for indexing items and responding to search queries. Embodiment 100 is a simplified example of one implementation of a search engine, as it may be deployed on a standalone system.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates the various components of a search engine as may be deployed in a single device. In some embodiments, the functional components described for the search engine may reside on many different devices, which may be configured for load balancing, for example. In some cases, the functions of the search engine may be deployed in a cloud-based computing platform.

The search engine of embodiment 100 may create an entropy sorted pyramid that groups elements, such as text elements, into levels based on their rareness or ‘entropy’. The more rare the element, the higher the entropy. The groups may be defined by including all elements having an entropy higher than a set of predefined levels. This arrangement may create a pyramid effect with the highest entropy elements being the smallest group, with each successive group comprising additional elements as the pyramid progresses to the bottom. An example of an entropy sorted pyramid is illustrated in embodiment 300 presented later in this specification.

A separate data structure may be used to store each of the different groups of elements. A data structure that stores the highest entropy elements may be the smallest data structure and may contain elements that are the rarest. A data structure that stores the lowest entropy elements may be the largest data structure.

The data structure may be any data structure that captures the relationships between elements. In one example, a suffix tree may be used to identify and store relationships between various elements. In another example, a phrase inverted index data structure may be used. A suffix tree may be capable of representing a phrase of infinite length; however, a phrase inverted data structure may be useful in embodiments where the complexity of the suffix tree may be avoided.

The data structure may include references to the source of the data. In the case of a text based item, the data source may be a group or collection of documents, a single document, or a subsection of a document. In some embodiments, a single element may have two or more different references to a source item, where one reference may be to the source document and the other reference to a subsection within the source document.

After the data structures are populated, a graph may be constructed from the data structures. The graph may include each indexed element as a node, with a relationship strength applied to each edge. From the graph, an adjacency matrix may be created and a transitive closure algorithm may be performed on the adjacency matrix.

A search request may be processed directly from the adjacency matrix, or by projecting the data structures through a filter and creating a graph based on the projection. In some such embodiments, a user interface may allow a user to browse through the graph to explore relationships prior to selecting a detailed view of the search results and view the underlying source document.

The device 102 is illustrated as a single, standalone device with hardware components 104 and software components 106. The embodiment 100 may illustrate a deployment of a search engine that may be used within a small network to search documents stored on various server and client devices.

The search engine described in embodiment 100 may be extensible to extremely large sets of data, such as the public Internet, which may contain billions of documents. In such an embodiment, various components of the search engine may be deployed over many server devices, with large groups of servers performing single tasks or functions.

In some embodiments, the search engine may be deployed as a desktop or device specific search engine, where the search engine performs searches over documents stored on a single device.

The device 102 is illustrated as a conventional computer device, such as a server computer or desktop computer. The device 102 may be a standalone device such as a personal computer, game console, or other computing device. In some embodiments, the device 102 may be a hand held or portable device such as a laptop computer, netbook computer, mobile telephone, personal digital assistant, or other device. In some embodiments, the device 102 may be a dedicated search device that may crawl a local area network and respond to search queries transmitted using a web browser, for example.

The hardware components 104 may include a processor 108, random access memory 110, and nonvolatile storage 112. The hardware components 104 may also include a network interface 114 and a user interface 116.

The software components 106 may include an operating system 118 and a file system 119. In embodiments where the search engine provides desktop or local search services, the search engine may index and search files located in the local file system 119.

The components of the search engine may include a document adapter 120 that may have several filters 122. The document adapter 120 may consume various documents or sources of data to index and search. In the example of a text search, the documents may be word processing documents, scanned documents that have undergone optical character recognition (OCR), email documents, website documents, text based items in a database, or any other text based item. The filters 122 may serve as a mechanism to capture data from specific types of documents. For example, one filter may be used for a word processing document, and another filter may be used for a slide presentation. The document adapter 120 may queue the documents for analysis by an input adapter 124.

The input adapter 124 may deconstruct the item to be searched into elements. In the case of a text document, an element may be a word or phrase. Specifically, the input adapter 124 may identify unigrams, bigrams, trigrams, and other groups of elements.

When the element is identified by the input adapter 124, the element may be assigned an identifier and stored in a text identifier database 126. The identifier may be an integer number, for example, that represents the element. Throughout the process of creating data structures, a graph combining the data structures, and an adjacency matrix, the elements may be referred to using their identifiers. The identifiers may be a simple technique for compressing the size of the databases and allowing more efficient processing. In some embodiments where the database is small or when the elements are consistent and small, the actual elements may be stored in the various databases and the text identifier database may not be used.

The input adapter 124 may identify certain elements within the item as being treated differently within the item. In a text search engine, the text that is underlined, bold, or italics may be identified as having additional importance. Similarly, text that is in the title of a document, used as a section heading, or the title of an illustration may have more relative importance than regular body text in a document. Those elements that are identified may be flagged or otherwise marked so that the relationships between the identified elements may be strengthened in the data structures or graph defined below.

In some embodiments, an input adapter 124 may have a noise suppressor 146. The noise suppressor 146 may identify and remove elements that may corrupt the searchable database. For example, some documents may contain metadata, special characters, embedded scripts, or other information that may be used by an application that creates or consumes the document. This information may be removed from the searchable elements for an item by the noise suppressor 146.

A language model processor 128 may analyze the individual elements to assign an entropy value to the elements. The entropy value may indicate how rare the element is in relation to other elements. For example, a term such as “counterexample” may be a relatively rare word in the English language and may have a high entropy value. In another example, the word “than” may be a very common word in English and may have a low entropy value.

The language model processor 128 may use one or more statistical language models to determine an entropy value for elements. Many embodiments may use a baseline language model 130 that may be a statistical language model for a language, such as American English. The statistical language model may assign a probability for one or more words based on a probability distribution for that language. The inverse of the probability may be the entropy assigned to the element.

A statistical language model for American English may contain on the order of 120,000 unigrams, 12,000,000 bigrams, and 4,000,000 trigrams.

A specialized language model 132 may be used when the items may contain information from specific technical fields, specific dialects, or contain words not commonly found or used in a baseline language model 130. For example, documents relating to the computer arts may contain certain words and phrases that have special meaning or are not commonly found in a baseline language model 130. Such a specialized language model 132 may contain a set of probabilities or entropy levels that are different from that of the baseline language model 130.

In some embodiments, a language model processor 128 may develop a customized statistical language model for the documents that are processed. For example, an enterprise may have a dialect of terms and phrases that are specific to that enterprise and for which a customized language model may be constructed.

After assigning an entropy to the elements, a database engine 134 may create an entropy sorted pyramid by grouping the elements according to their entropy. An example of an entropy sorted pyramid is illustrated in embodiment 300 presented later in this specification.

The entropy sorted pyramid may be a grouping of the elements base on entropy. In one embodiment, those elements having an entropy above a threshold may be grouped together. Another group may be the elements with an entropy above another lower threshold. The members of the first group may also be found in the second group.

A data structure 136 may contain all of the elements from a specific entropy level. Each of the entropy groupings may have a data structure 136 that may capture the elements in the groupings. For example, in an embodiment with five levels of entropy groupings, there may be five instances of a data structure 136.

The data structures 136 may capture the elements in the entropy grouping and the relationships between those elements. For example, a suffix tree built from text strings may be capable of storing sequences of text elements. The relationships between elements and proximity of elements to each other may come out in the analysis performed on the indexed data in later steps.

A graph 138 may consolidate the data structures 136 to create a graph that has the vertices as the elements and the edges as the connections to other elements. For each element, every element to which the same element has a direct relationship may have an edge between them. The edge may be defined with a weighting.

In one embodiment, the edge weighting may be defined using a Jaccard similarity, which can be defined as:

$$J = \frac{\vert A ⋂ B \vert}{\vert A ⋃ B \vert}$$

The edge weighting can be defined by dividing the intersection of two nodes with the union of two nodes. The values in the nodes may be the document references contained in the nodes.

The graph 138 may contain all of the data from all of the data structures 136. In some embodiments, each data structure may have a different weight applied. For example, the data structure representing the highest entropy elements may be assigned a higher weighting than the other data structures, since the highest entropy elements may be assumed to represent more important relationships than the lower entropy elements.

An adjacency matrix 144 may be created from the graph 138. In one embodiment, the database engine 134 may create an adjacency matrix 144 that contains the relationship values from each element to every other element. In some embodiments, a query engine 140 may be able to perform queries against the adjacency matrix 144 directly.

In some embodiments, a query engine 140 may create a graph 138 from the data structures 136 in response to a query. In such an embodiment, the query engine 140 may receive various parameters that may filter or exclude certain types of data. In a simple example, a user may request a search that limits the scope of the search to email documents, excluding word processor and other documents.

After receiving the filter parameters, a projection of the data structures 136 may result in a pruned set of data structures. From those data structures, a graph may be constructed and used to present data to a user. In some embodiments, the user may be able to browse the graph visually and inspect the related terms and the strength of the relationships between them.

A correlation engine 142 may execute a transitive closure algorithm on the adjacency matrix 144 to identify relationships between entities where no direct relationship exists. One algorithm for performing transitive closure may be the Floyd-Warshall algorithm.

The correlation engine 142 may operate as a background process. In such an operation, the correlation engine 142 may lock a single row in the adjacency matrix 144 and perform a transitive closure algorithm on the locked row. Before unlocking the row, the correlation engine 142 may update the row. Once unlocked, the row may be used by a query engine 140 to perform searches.

The device 102 is illustrated as a search engine that may operate in a network 148, which may be a local area network or a wide area network. A crawler 150 may crawl devices attached to the network 148 and retrieve documents for the search engine on device 102 to process. For example, servers 152 may have various documents 154, as well as clients 156 may have documents 158. Similarly, web services 160 may also have documents 162.

The device 102 may be configured to respond to search query requests from clients 156, servers 152, or web services 160.

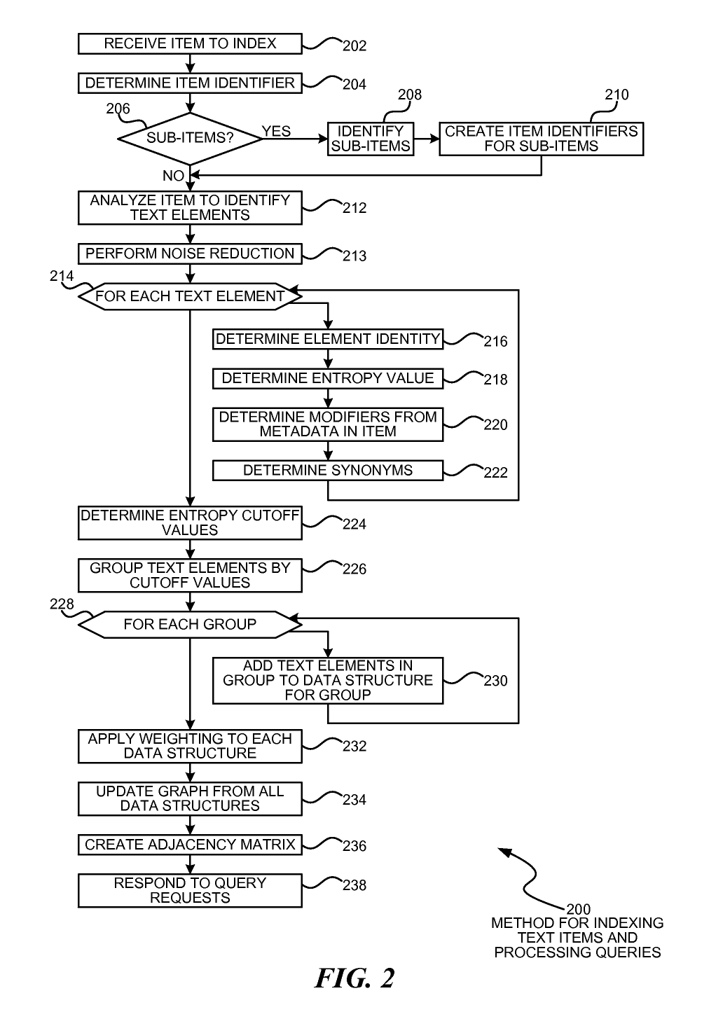

FIG. 2 is a flowchart illustration of an embodiment 200 showing a method for indexing text items and processing queries. Embodiment 200 is a simplified example of a process that may be performed by the various components of the search engine as illustrated in embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a method for processing an item and adding the item's elements to data structures. The elements may be classified and grouped by entropy to create an entropy sorted pyramid. The groups may be added to data structures, then the data structures combined to create a graph from which searches may be performed.

An item to index may be received in block 202. The item may be anything that can be broken into elements and for which a search may be performed. In the examples discussed in embodiment 200, the item may be a text based document and the elements may be words or phrases within those documents. However, other embodiments may use different items with different elements. For example, a search engine may be used for searching DNA sequences. In such an example, the items may be documents or files containing DNA mappings, and the elements may be short portions of DNA sequences.

In the example of a text base search engine, the items may be documents stored in a file system, such as word processing documents, scanned documents, presentation documents, spreadsheets, and other documents. The documents may also include email messages, instant message transcripts, or other text based communication. Some embodiments may include video and audio files, where the video and audio files may contain text in the form of tags, titles, and other metadata.

In some embodiments, the items may be retrieved from a database or other service. For example, some embodiments may query an accounting database to pull reports from the database, or may query a web service to pull information or documents.

Some embodiments may employ a crawler to find documents residing in specific folders, the file systems of various devices, or other documents located on a local file system or on remote devices across a local or wide area network.

An item identifier may be created in block 204. The item identifier may be an index in a table that contains the full address to the item. The address may be in the form of a Uniform Resource Identifier (URI) or other format. The item identifier may be used in the data structures as a shorthand notation for the item.

In some embodiments, an item may have sub-items. For example, a lengthy word processing document may have chapters, sections, or other sub-items defined within the document. In another example, a scanned document may have each page of a multi-page document considered as a sub-document.

If sub-items exist in the document in block 206, the sub-items may be identified in block 208 and item identifiers may be created for the sub-items in block 210.

When sub-items are used in an embodiment, the item table described above may contain two or more entries for each item, with the primary item being the sub-item that contains an element. For example, a document with multiple chapters may have sub-items defined for each chapter. For each chapter, the primary item used in the indexed database may be the chapter sub-item identifier, with an additional item identifier in an item table for the overall document item identifier.

In block 212, the item may be analyzed to identify text elements. The analysis may identify words or phrases in the example of a text based document.

In block 213, a noise reduction algorithm may clean up any elements that may not make sense. For example, many documents may contain formatting or other metadata that is not displayed to a user. In some cases, such elements may contain non-alphanumeric data and special characters. Such characters or formatting may be incorrectly identified as having very high entropy in later processing steps and may corrupt the database. In many cases, filters may be created for specific document types that may identify non-text elements and remove those elements from being processed.

Each text element may be processed in block 214. For each element, an element identity may be determined in block 216 and an entropy value determined in block 218.

The element identity may be an integer or other index that may refer to the element. In many cases, the element may be stored in an element table that may contain the index and the actual element. When an element is processed in block 216, a lookup may be performed to the element table to determine if the element has already been used. If so, the index from the successful search may be used for the element.

In some embodiments, a standard dictionary of elements may be used. Such an embodiment may be useful when two or more search engine databases may be combined. In one example embodiment, a statistical language model may contain a dictionary of elements with pre-defined indexes.

The entropy value of the element in block 218 may be determined from the probability value determined from a statistical language model. An entropy value may be calculated by taking the inverse of the probability value as determined by a statistical language model.

In some embodiments, two or more statistical language models may be used. In such embodiments, a baseline language model may represent a commonly spoken or general purpose language model, with additional language models containing language elements that are specific to different industries, technologies, dialects, or other nuances of a specific application.

When two or more language models are used, the language models may be queried in a predefined order, with the first language model to contain the element containing the entropy used for the element. For example, a database that indexes computer science documents may have a computer science statistical language model that includes probabilities or entropies for different terms used in the computer science world. When a computer science term is encountered and the computer science statistical language model contains the term, the entropy for that term may be assigned to the term and the baseline statistical language model may not be consulted. In the same embodiment, a term that is not defined in the computer science statistical language model may be found in the baseline statistical language model, from which the entropy may be determined

In block 220, any modifiers for the element may be determined from metadata within the item. For example, elements that are highlighted, bold, or have different formatting from the bulk of the elements may be considered of higher importance than other elements. In some embodiments, the modifiers may be added to the entropy value, raising the rareness or importance of the element.

Other examples of the modifiers may include when the element may be used as a title of a document or section of a document, as well as when the element may be used as a title of a figure, table, or illustration.

In some cases, a modifier may reduce the importance of an element. For example, an element in a footnote or smaller font size may be considered less important than normal body text. In such a case, the modifier may reduce the entropy associated with the element.

Synonyms for an element may be determined in block 222. In some embodiments, the synonyms may be used by adding the synonyms to text strings or creating new text strings that incorporate various synonyms.

After each text element is individually processed in block 214, a set of entropy cutoff values may be determined in block 224 that the text elements may be grouped by the cutoff values in block 226. An example of such a process may be illustrated in embodiment 300.

The entropy cutoff values may define the different groups of elements to create an entropy sorted pyramid. In many embodiments, the entropy cutoff values may be pre-defined and applied to all items in the searchable database equally. In other embodiments, the entropy cutoff values may be recalculated for every item or document that may be analyzed. In such an embodiment, the entropy cutoff values may be defined based on a maximum entropy value for the document and determining entropy cutoff values based on the maximum value.

Each group of elements may be processed in block 228. For each group, the text elements in the group may be added to the data structure for that group. In the case where a suffix tree is used, the suffix tree may be searched to identify a first element in the group, then the group may be added from that element.

In some embodiments, the first item to be indexed may be used to create the first suffix tree or other data structure from a blank data structure. In some embodiments, a baseline data structure that may be pre-populated may be used for the first item that is indexed.

After each element group has been added to the respective data structures, a weighting may be applied to each data structure in block 232 and a graph may be created or updated in block 234.

The graph may be defined by collecting each instance of an element in each of the data structures and identifying edges to any other element that may be the element's neighbor. The edges of the graph may be weighted using the Jaccard index or other formula to determine a weighting or strength of the relationship.

When combining the data structures, a different weight may be applied to each data structure as a whole. The data structures with higher entropy cutoffs may be considered more important than the lower entropy data structures, and therefore may be weighted higher. The weightings may be used when computing the edge relationships in the graph.

The graph may be represented by an adjacency matrix in block 236. The adjacency matrix may have rows that represent each element and columns that represent each element. The values in the adjacency matrix may represent the strength of the relationships between the two intersecting elements.

The adjacency matrix may be an upper triangular matrix, and may also be sparsely populated. In some embodiments, such as embodiment 400, a transitive closure algorithm may be performed on the adjacency matrix.

In some embodiments, the full adjacency matrix may be used to respond to query requests in block 238. In other embodiments, a new graph may be created in response to a search query, as illustrated in embodiment 500.

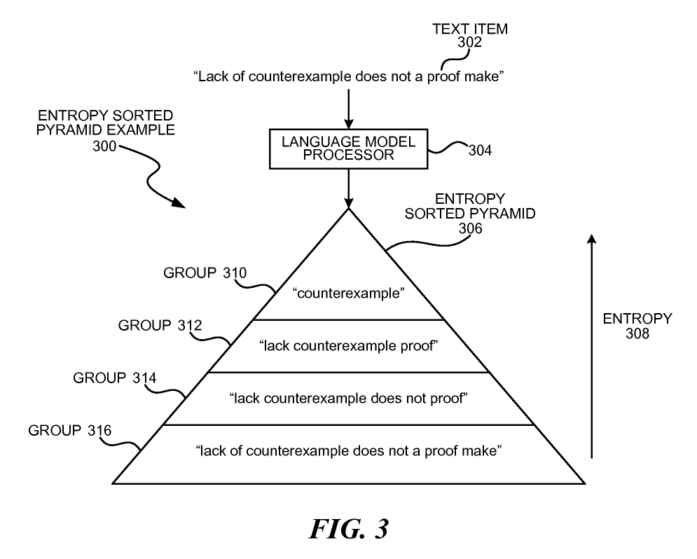

FIG. 3 is a diagram of an embodiment 300, showing an example of an entropy sorted pyramid. Embodiment 300 is a simplified example of a text item 302 that may be processed by a language model processor 304 to produce an entropy sorted pyramid 306.

In the example of embodiment 300, a text item 302 may contain “Lack of counterexample does not a proof make”. When processed by a language model processor 304, such as the language model processor 128 of embodiment 100 or through the steps 214 through 222 of embodiment 200, the elements of the text item 302 may be analyzed and an entropy valued applied.

Based on the entropy value of the individual words and a set of entropy thresholds, the words may be grouped into groups 310, 312, 314, and 316. The groups are arranged in the entropy sorted pyramid 306 according to entropy 308, with the highest entropy group being at the top.

Group 310 may contain the highest entropy word, which is ‘counterexample’. Group 312 may contain the words having an entropy value greater than a threshold, and those words may be ‘lack counterexample proof’. Because the algorithm for the grouping takes any element with an entropy value greater than a threshold, each successive level or grouping in the entropy sorted pyramid may include the words from the higher levels. Similarly, group 314 contains ‘lack counterexample does not proof’ and group 316 contains ‘lack of counterexample does not a proof make’.

Each of the various groups may be added to a data structure for the respective level. For example, a data structure for the highest level group 310 may receive the text ‘counterexample’ and a separate data structure for the next level group 312 may receive the text ‘lack counterexample proof’.

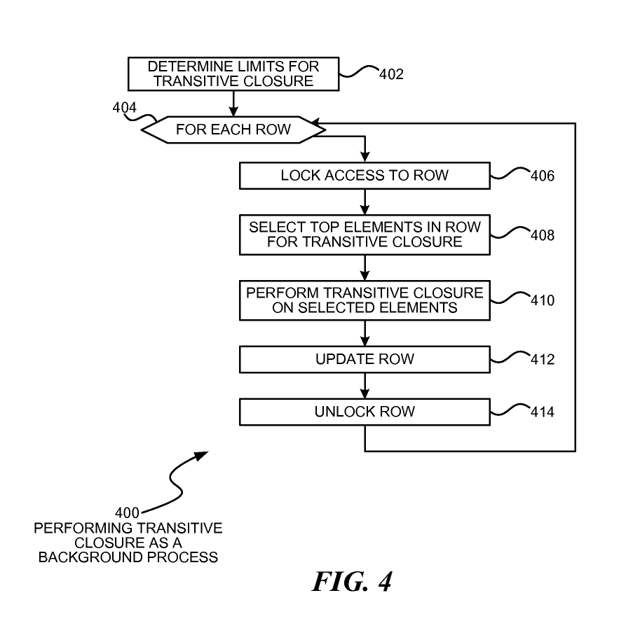

FIG. 4 is a flowchart illustration of an embodiment 400 showing a method for performing transitive closure as a background process. Embodiment 400 is an example of a process that may be performed by a correlation engine 142 that may perform transitive closure over an adjacency matrix while the adjacency matrix is available for responding to queries.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of a process that may perform transitive closure over an adjacency matrix. Transitive closure may measure the relative distance over a path between the elements, and compute a relationship strength for elements that are not directly connected.

Throughout the process of creating data structures and building a graph, the relationships between elements can be determined only for those relationships between elements that are directly next to each other. In the example of embodiment 300, the text ‘counterexample’ may have direct relationships between the terms ‘lack’ and ‘proof’ from group 312, as well as direct relationships with the term ‘does’ and ‘of’ from groups 314 and 316. These relationships may be determined from the data structures, such as a suffix tree, and creating a graph from the various data structures. However, the element ‘counterexample’ does not have a direct relationship with the term ‘make’. Such a relationship may be uncovered through a transitive closure algorithm.

The transitive closure algorithm may be performed on an adjacency matrix on a row by row basis. During the operation, a single row may be locked from access while the transitive closure algorithm is performed. After updating the relationships in the row, the row may be unlocked and the process may be performed on a different row. Such an embodiment may perform the transitive closure in a background process while the remainder of the adjacency matrix is used for processing search queries.

In block 402, a set of limits may be defined for transitive closure. In many cases, transitive closure algorithms, such as the Floyd-Warshall algorithm, may operate more efficiently with a limited set of input values. The limits defined in block 402 may identify a subset of all values in a row by several different methods. In one embodiment, the limits may define a minimum value of a relationship strength and may ignore the values less than the minimum value. In another embodiment, the limits may define a maximum number of elements to process. In such an embodiment, the elements in the row may be sorted and the number of elements processed may equal the maximum number defined in the limit.

Each row may be processed in block 404. For each row that will be processed in block 404, access to the row may be locked in block 406. The elements in the row that meet or exceed the limits defined in block 402 may be identified in block 408.

Transitive closure may be performed on the selected elements in block 410.

After the transitive closure is performed in block 410, the row may be updated in block 412 and the row unlocked in block 414. The process may return to block 404 to process additional rows.

When the corpus of documents in the search index is very small, the transitive closure algorithm may be rather quick and may identify relationships that are not explicit in the raw indexed data. When the corpus of documents in the search index is very large, there may be a very large number of direct relationships between elements and the effects of a transitive closure algorithm may be much less than when the corpus of documents is small. In cases where very large corpuses are used, the transitive closure algorithm may be omitted.

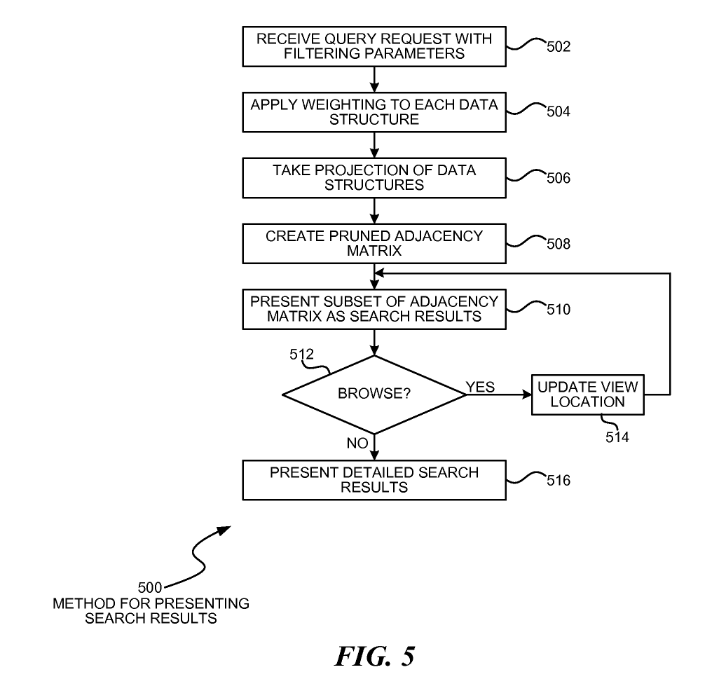

FIG. 5 is a flowchart illustration of an embodiment 500 showing a method for collecting and presenting search results. Embodiment 500 is merely one method for responding to a search result, where a new adjacency matrix may be created in response to the search result.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 502, a query request may be received with filtering parameters. The filtering parameters may define documents to include and exclude, or other factors that may restrict the corpus of documents to search. For example, the filter parameters may define a search that includes all word processing documents and excludes those that are older than a year.

A new adjacency matrix may be created by applying a weighting to each data structure in block 504 and taking a projection from each of the data structures in block 506. The projection may filter or prune the data structures to remove the portion of data structures that are excluded from the search request. From the projected data structures, a pruned adjacency matrix may be created in block 508.

The adjacency matrix may be used to present a subset of the adjacency matrix in block 510. If a user wishes to browse the results in block 512, an updated view location may be determined in block 514 and the process may loop back to illustrate the selected portion of the adjacency matrix in block 510. At some point, the user may end the browsing in block 512 and may be presented with a detailed search result in block 516.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a item comprising text strings;
determining an item identifier for said item;
processing said text strings with a statistical language model to:
identify text elements;
determining text element identifiers for said text elements; and
assign an entropy value to each of said elements;
selecting a first subset of said text elements, each of said text elements in said first subset having an entropy value greater than a first predefined entropy value;
adding each of said text elements to a first data structure, said first data structure comprising said text element identifiers and said item identifier;
creating an adjacency matrix representing a graph comprising vertices representing said text elements and edges representing weighted relationships, said weighted relationships being determined from said first data structure; and
receiving a search query for a first text element and responding with search results derived from said adjacency matrix.

2. The method of claim 1 further comprising:
performing transitive closure on said adjacency matrix using a first algorithm to populate said adjacency matrix with additional values.

3. The method of claim 2, said first algorithm being the Floyd-Warshall algorithm.

4. The method of claim 1, said first data structure comprising a suffix tree comprising edges representing said text elements and nodes comprising said item identifier.

5. The method of claim 1, said first data structure comprising a phrase inverted index data structure.

6. The method of claim 1 further comprising:
selecting a second subset of said text elements, each of said text elements in said second subset having an entropy value greater than a second predefined entropy value;
adding each of said second subset of text elements to a second data structure, said second data structure comprising said text elements and said item identifier; and
said edges in said graph being further determined from said first data structure and said second data structure.

7. The method of claim 6 further comprising:
said edges being determined in part by applying a first weighting to said first data structure and a second weighting to said second data structure prior to determining said edges.

8. The method of claim 1 further comprising:
performing noise reduction on said item prior to said processing.

9. The method of claim 1, said text elements comprising at least one of a group composed of:
unigrams;
bigrams; and
trigrams.

10. The method of claim 1 further comprising:
identifying a first text element;
determining a synonym for said first text element; and
adding said synonym to said first subset of text elements.

11. The method of claim 1 further comprising:
examining said item to determine a formatting characteristic for a first text item; and
weighting said first text item based on said formatting characteristic.

12. The method of claim 11, said formatting characteristic comprising at least one of:
a title;
a heading;
a font effect; and
a font modifier.

13. A system comprising:
a document adapter that:
receives an item comprising text elements; and
creates an item identifier for said item;
an input adapter that:
parses said item into text elements; and
for each of said text elements, assigns a text element identifier;
a language model processor that:
assigns an entropy value to each of said text element based on a statistical language model;
a database engine that:
selects a first subset of said text elements, each of said text elements in said first subset having an entropy value greater than a first predefined entropy value;
adds each of said text elements to a first data structure, said first data structure comprising said text element identifiers and said item identifier; and
creates an adjacency matrix representing a graph comprising vertices representing said text elements and edges representing weighted relationships, said weighted relationships being determined from said first data structure;
a query engine that:
receives a first query comprising a first text element; and
returns results derived from said adjacency matrix, said results comprising observed results.

14. The system of claim 13 further comprising:
a background processor that:
locks a first row of said adjacency matrix;
while said first row is locked, performs transitive closure on said first row of said adjacency matrix using a first algorithm that determines a shortest path between two of said vertices in said graph; and
unlocks said first row when said transitive closure is completed on said first row.

15. The system of claim 14, said language model processor using a plurality of said statistical language models to determine said entropy value.

16. The system of claim 15, one of said statistical language models being a specialized language model.

17. The system of claim 13, said item being at least one of a group composed of:
a group of documents;
a document; and
a subsection of a document.

18. A method performed on a computer processor, said method comprising:
receiving a item comprising text strings;
determining an item identifier for said item;
processing said text strings with a statistical language model to:
identify text elements;
determining text element identifiers for said text elements; and
assign an entropy value to each of said elements;
determining a plurality of entropy level cutoffs;
creating a plurality of groups of said text elements, each of said plurality of groups having an entropy value greater than one of said plurality of entropy level cutoffs;
adding each of said group of text elements to a corresponding data structure comprising said text element identifiers and said item identifier;
creating a graph comprising vertices representing said text elements and edges representing weighted relationships, said weighted relationships being determined from each of said corresponding data structures; and
receiving a search query for a first text element and responding with search results derived from said graph, said search results being observed search results.

19. The method of claim 18 further comprising:
applying a first weighting to a first corresponding data structure and a second weighting to a second corresponding data structure when creating said graph.

20. The method of claim 19 further comprising:
generating an adjacency matrix from said graph using a first algorithm that determines a shortest path between two of said vertices in said graph; and
in response to said search query, responding with second search results derived from said adjacency matrix, said second search results comprising inferred search results.
